(19) United States
(12) Patent Application Publication
(10) Pub. No.: US 2026/0193426 A1
(43) Pub. Date: Jul. 9, 2026

(54) THERMAL PROTECTIVE MATERIAL, COATING, LAYER, PLATE AND BLOCK

(71) Applicant: BOARD OF REGENTS FOR THE OKLAHOMA AGRICULTURAL AND MECHANICAL COLLEGES, STILLWATER, OK (US)

(72) Inventors: M. Tyler Ley, Stillwater, OK (US); Ali Jarekji, Stillwater, OK (US); Aedan C. Cottle, Midwest City, OK (US); Christian D. Branch, Ponca City (UA); Andrew M. Abernathie, Broken Arrow, OK (US); Bethany D. Trammell, Tulsa, OK (US); Isabel Athena Ley, Stillwater, OK (US)

(21) Appl. No.: 18/868,501

(22) PCT Filed: May 24, 2023
(86) PCT No.: PCT/US2023/023294

§ 371 Date: Nov. 22, 2024

Related U.S. Application Data
(60) Provisional application No. 63/345,092, filed on May 24, 2022.

(51) Int. Cl. C08J 3/205; C08J 3/24

(52) U.S. Cl. CPC C08J 3/205; C08J 3/24; C08J 2305/06

(57) ABSTRACT

The invention concerns various formulations of polysaccharide, sodium bicarbonate, adhesive, water and sodium borate for preparing a heat resisting thermal protective material providing thermal protection for substrates and structures. When pliant, the thermal protective material according to the invention may be shaped into a geometric form such as a coating, a layer, a plate, tile or block. Once the material cures from its pliant state it becomes an intumescent, ablative material wherein its resistance to heat increases as it combusts. The length of time that thermal protection is afforded is proportional to the thickness of the coating, layer, plate, tile or block.

### CROSS REFERENCE TO RELATED APPLICATIONS

This application is based upon and claims benefit of priority to U.S. Provisional Application No. 63/345,092, filed May 24, 2022, which application is hereby incorporated by reference herein.

### FIELD OF THE INVENTION

This invention concerns mixture formulations for preparing thermal protective materials.

### BACKGROUND

The combustion gas temperature within the combustion chamber of a rocket engine may reach 6,000° F. (3,315° C.). Although the gases cool as they expand and exit through the rocket engine nozzle, the exhaust plume remains hot enough to fuse the surface of the concrete forming the launch pad into a layer of glass. As this is undesirable because it compromises the structural integrity of the launch pad it would be advantageous to apply a layer of thermal protective material to prevent such damage.

### SUMMARY

The invention concerns a formulation for a thermal protective material. By way of example, the formulation may comprise a polysaccharide, sodium bicarbonate and an adhesive. The polysaccharide may comprise amylose and amylopectin. The adhesive may comprise a polymer comprising propylene. In a specific example, the adhesive comprises an aqueous emulsion of polyvinyl acetate, polyvinyl alcohol and propylene glycol. An example formulation according to the invention may further comprise water and sodium borate. In an example embodiment, the sodium borate may comprise sodium tetraborate pentahydrate.

In practical example formulations according to the invention, a ratio of the polysaccharide to the sodium bicarbonate ranges from 90:10 to 80:20 by weight percent.

In example formulations according to the invention, the polysaccharide comprises from 47 weight percent to 7 weight percent; the sodium bicarbonate comprises from 12 weight percent to 66 weight percent; and the adhesive comprises from 41 weight percent to 26 weight percent.

In example formulations according to the invention the polysaccharide comprises 47 weight percent; the sodium bicarbonate comprises 12 weight percent; and the adhesive comprises 41 weight percent.

In example formulations according to the invention the polysaccharide comprises 41 weight percent; the sodium bicarbonate comprises 18 weight percent; and the adhesive comprises 42 weight percent.

In example formulations according to the invention the polysaccharide comprises 37 weight percent; the sodium bicarbonate comprises 24 weight percent; and the adhesive comprises 39 weight percent.

In example formulations according to the invention the polysaccharide comprises 31 weight percent; the sodium bicarbonate comprises 31 weight percent; and the adhesive comprises 38 weight percent.

In example formulations according to the invention the polysaccharide comprises 26 weight percent; the sodium bicarbonate comprises 39 weight percent; and the adhesive comprises 35 weight percent.

In example formulations according to the invention the polysaccharide comprises 21 weight percent the sodium bicarbonate comprises 49 weight percent; and the adhesive comprises 30 weight percent.

In example formulations according to the invention the polysaccharide comprises 14 weight percent; the sodium bicarbonate comprises 57 weight percent; and the adhesive comprises 28 weight percent.

In example formulations according to the invention the polysaccharide comprises 7 weight percent; the sodium bicarbonate comprises 66 weight percent; and the adhesive comprises 46 weight percent.

In an example formulation the adhesive may comprise 42 weight percent.

In example formulations according to the invention the polysaccharide comprises from 46 weight percent to 6 weight percent; and the sodium bicarbonate comprises from 12 weight percent to 58 weight percent.

In example formulations according to the invention the polysaccharide comprises 46 weight percent and the sodium bicarbonate comprises 12 weight percent.

In example formulations according to the invention the polysaccharide comprises 41 weight percent and the sodium bicarbonate comprises 17 weight percent.

In example formulations according to the invention the polysaccharide comprises 35 weight percent and the sodium bicarbonate comprises 23 weight percent.

In example formulations according to the invention the polysaccharide comprises 29 weight percent and the sodium bicarbonate comprises 29 weight percent.

In example formulations according to the invention the polysaccharide comprises 23 weight percent and the sodium bicarbonate comprises 35 weight percent.

In example formulations according to the invention the polysaccharide comprises 17 weight percent and the sodium bicarbonate comprises 41 weight percent.

In example formulations according to the invention the polysaccharide comprises 12 weight percent and the sodium bicarbonate comprises 46 weight percent.

In example formulations according to the invention the polysaccharide comprises 6 weight percent and the sodium bicarbonate comprises 52 weight percent.

In example formulations according to the invention the polysaccharide comprises 43.9 weight percent, the sodium bicarbonate comprises 10.9 weight percent, the adhesive comprises 33.6 weight percent, the water comprises 10.9 weight percent and the sodium borate comprises 0.4 weight percent of a 5 percent solution of sodium tetraborate pentahydrate.

In example formulations according to the invention the polysaccharide comprises 42.3 weight percent, the sodium bicarbonate comprises 10.6 weight percent, the adhesive comprises 32.4 weight percent, the water comprises 14.1 weight percent and the sodium borate comprises 0.7 weight percent of a 5 percent solution of sodium tetraborate pentahydrate.

In example formulations according to the invention the polysaccharide comprises 42.5 weight percent, the sodium bicarbonate comprises 10.6 weight percent, the adhesive comprises 32.6 weight percent, the water comprises 14.2 weight percent and the sodium borate comprises 0.1 weight percent of a 5 percent solution of sodium tetraborate pentahydrate.

In example formulations according to the invention the polysaccharide comprises 39.7 weight percent, the sodium bicarbonate comprises 9.9 weight percent, the adhesive comprises 30.4 weight percent, the water comprises 19.8 weight percent and the sodium borate comprises 0.13 weight percent of a 5 percent solution of sodium tetraborate pentahydrate.

In example formulations according to the invention the polysaccharide comprises 37.2 weight percent, the sodium bicarbonate comprises 9.3 weight percent, the adhesive comprises 28.5 weight percent, the water comprises 24.8 weight percent and the sodium borate comprises 0.12 weight percent of a 5 percent solution of sodium tetraborate pentahydrate.

In example formulations according to the invention the polysaccharide comprises 44.0 weight percent, the sodium bicarbonate comprises 11.0 weight percent, the adhesive comprises 33.7 weight percent, the water comprises 11.0 weight percent and the sodium borate comprises 0.15 weight percent of a 5 percent solution of sodium tetraborate pentahydrate.

In example formulations according to the invention the polysaccharide comprises 45.7 weight percent, the sodium bicarbonate comprises 11.4 weight percent, the adhesive comprises 35.1 weight percent, the water comprises 7.6 weight percent and the sodium borate comprises 0.15 weight percent of a 5 percent solution of sodium tetraborate pentahydrate.

In example formulations according to the invention the polysaccharide comprises 44.2 weight percent, the sodium bicarbonate comprises 11.0 weight percent, the adhesive comprises 39.4 weight percent, the water comprises 5.2 weight percent and the sodium borate comprises 0.21 weight percent of a 5 percent solution of sodium tetraborate pentahydrate.

In example formulations according to the invention the polysaccharide comprises 24.4 weight percent, the sodium bicarbonate comprises 36.6 weight percent, the adhesive comprises 33.4 weight percent, the water comprises 5.4 weight percent and the sodium borate comprises 0.22 weight percent of a 5 percent solution of sodium tetraborate pentahydrate.

In example formulations according to the invention wherein the polysaccharide comprises 6.9 weight percent, the sodium bicarbonate comprises 62.4 weight percent, the adhesive comprises 23.9 weight percent, the water comprises 6.5 weight percent and the sodium borate comprises 0.26 weight percent of a 5 percent solution of sodium tetraborate pentahydrate.

In an example formulation according to the invention the polysaccharide may comprise from 7 weight percent to 93 weight percent.

In an example formulation according to the invention the sodium bicarbonate may comprise from 9 weight percent to 66 weight percent.

In an example formulation the adhesive may comprise from 26 weight percent to 42 weight percent.

An example formulation may further comprise water and sodium borate. By way of example, the water may comprise from 5 weight percent to 25 weight percent.

In example formulations according to the invention, the sodium borate may comprise from 0.1 weight percent to 0.7 weight percent of a 5 percent solution of sodium borate.

The invention also encompasses a method of preparing a thermal protective material using a formulation as described above. An example method according to the invention may comprise:
mixing the polysaccharide and the sodium bicarbonate;
during the mixing, adding the adhesive to the polysaccharide and the sodium bicarbonate thereby forming a mixture.

An example method may further comprise the step of during the mixing adding the water and the sodium borate.

An example method may further comprise the step of halting the mixing and allowing the mixture to cure.

An example method may further comprise the step of halting the mixing and allowing the mixture to cure.

An example method may further comprise the step of applying the mixture to a substrate and then allowing the mixture to cure.

An example method may further comprise the step of applying the mixture as a layer upon the substrate.

An example method may further comprise the step of applying the mixture to a substrate after allowing the mixture to cure.

The invention also encompasses a thermal protective material using a formulation as described above. The thermal protective material according to the invention may have a geometric form including a coating, a layer, a plate, a block, and combinations thereof.

### BRIEF DESCRIPTION OF THE DRAWINGS

FIG. 1 is an isometric view of an I beam having an example coating of a thermal protective material according to the invention;

FIG. 2 is an isometric view of a surface having an example layer of a thermal protective material according to the invention;

FIG. 3 is an isometric view of an example plate or tile formed of a thermal protective material according to the invention; and

FIG. 4 is an isometric view of an example block formed of a thermal protective material according to the invention.

### DETAILED DESCRIPTION

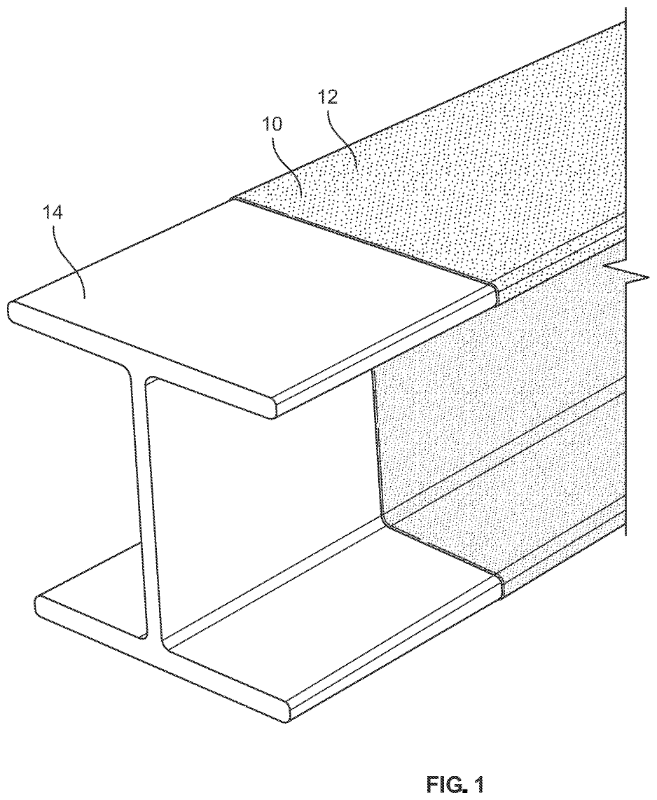

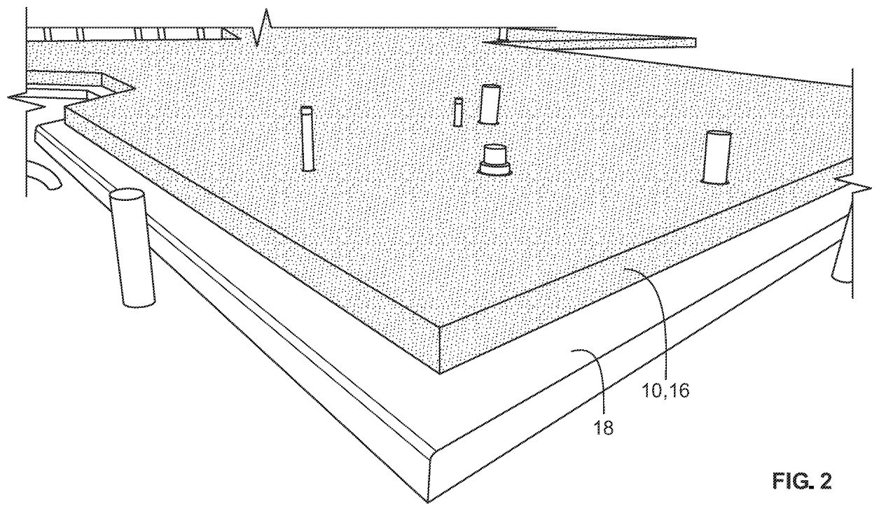

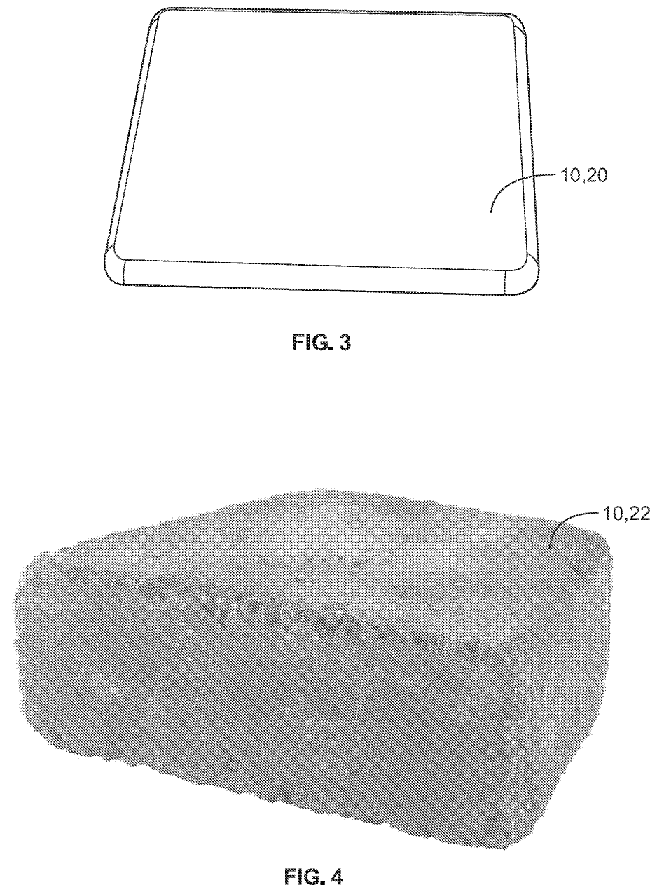

The invention concerns various formulations for preparing a heat resisting thermal protective material providing thermal protection of substrates and structures. When pliant, the thermal protective material according to the invention may be shaped into a geometric form. The pliant material 10 may be applied as a coating 12 to a structure, such as the “I” beam 14 shown in FIG. 1. As shown in FIG. 2, the thermal protective material 10 may also be laid to form a thermal protective layer 16 over a surface 18, such as the surface of a rocket launch pad. Material 10 may also be formed into plates or tiles 20, as shown in FIG. 3, or blocks 22 of various shapes as shown in FIG. 4. The plates 20 and blocks 22 may be formed to a shape conforming to a structure or item to be protected. Once the material cures from its pliant state the material becomes an intumescent, ablative material wherein its resistance to heat increases as it combusts. The length of time that thermal protection is afforded is proportional to the thickness of the coating, layer, plate or block.

An example formulation for a thermal protective material according to the invention comprises a mixture of a polysaccharide, sodium bicarbonate and an adhesive. In a specific example formulation described herein, the polysaccharide comprises amylose and amylopectin and the adhesive comprises a polymer comprising propylene. More specifically, the adhesive may comprise an aqueous emulsion of polyvinyl acetate, polyvinyl alcohol and propylene glycol. For the formulations forming the test samples described herein the polysaccharide was ARGO brand cornstarch, the sodium bicarbonate was Arm & Hammer brand baking soda, and the adhesive was Elmer's brand White School Glue. Example formulations of the material according to the invention may also comprise water and sodium borate. These materials can act as a dispersant and/or a catalyst. In the specific test samples described herein the sodium borate comprised sodium tetraborate pentahydrate commercially available as Milliard brand Borax. Table 1 provides characteristics of the constituent materials used in the example formulations according to the invention. The formulation is not limited to the brands of material disclosed herein.

TABLE 1
Sodium Bicarbonate
Composition: NaHCO₃
Brand Used: Arm & Hammer
pH: 8.31
Structure: Monoclinic Crystalline
Appearance: White Crystalline Powder
Melting Point: 50° C. (228° F.). Releases CO₂, H₂O, NA₂CO₃. Total
decomposition at 270° C.
Particle Size: 70-160 microns
Polysaccharide
Composition: Amylose and Amylopectin (C₆H₁₀O₅)ₙ
Brand Used: ARGO
pH: 7
Structure: homopolymers of repeating anhydroglucose units (AGU)
joined by alpha-glycosidic linkage (2)
Appearance: fine white powder
Melting Point: 257° C.
Gelatinization temperature: 62-72° C.
Particle Size: 5-26 microns
Adhesive
Composition: Polyvinyl Acetate (C₄H₆O₂)ₙ
Brand Used: Elmer's White School Glue
pH: 4.5-5.5
Structure: Synthetic Polymer
Appearance: Opaque White Liquid
Sodium Borate
Composition: Sodium Tetraborate Pentahydrate (B₄O₇Na₂•10H₂O)
Brand Used: Milliard Borax
pH: 9.5
Appearance: White Crystalline Solid
Melting Point: 743° C.
Particle Size: 30-70 Microns

A practical thermal protective material requires certain physical properties be met. For example, the material must be flowable enough that it can be formed and placed but also pliant enough that it will hold a shape. This will allow the material to coat a block, plate, or a complex shape of the underlying structure. It is desirable for the material to harden or cure (dry) within a reasonable period of time and without significant shrinkage or cracking. Shrinkage is expressed as a percentage loss of volume when cured compared with the initial volume when pliant. Crack widths and depths are measured in inches or centimeters. The material must of course provide thermal protection, and this parameter is measured by the burn-through rate with an oxygen acetylene torch of temperature>6,000° F. The burn-through rate is measured by the time in seconds per inch or centimeter of penetration.

Practical formulations according to the invention were in part determined by preliminary tests wherein the ratio of polysaccharide to sodium bicarbonate was varied, and it was established that a range of this ratio from 90:10 to 80:20 by weight percent would likely provide a practical formulation. The adhesive was varied to provide acceptable workability to the mixture. Both the 90:10 polysaccharide to sodium bicarbonate ratio (51 wt % polysaccharide, 6 wt % sodium bicarbonate, 44 wt % adhesive) and the 80:20 polysaccharide to sodium bicarbonate ratio (47 wt % polysaccharide, 12 wt % sodium bicarbonate, 42 wt % adhesive) produced a workable putty having respective shrinkage rates of 9.8% and 5.8%. Respective burn-through rates of 67 s/in and 62 s/in were achieved for these test mixtures.

With a practical ratio range of polysaccharide to sodium bicarbonate established, various sample mixture formulations for the thermal protective material were prepared and evaluated within the range, as summarized in tables 2A-5B below.

The sample formulations were prepared according to the following procedure using a Hobart industrial mixer:
1. Sift clumps from dry ingredients with 60-mesh screen (250 microns) or No. 50 sieve (300 microns);
2. Weigh each dry ingredient;
3. Add dry ingredients to the bowl of a Hobart mortar mixer (as described in ASTM C 109);
4. Attach flat beater or spiral hook and the bowl guard;
5. Mix dry ingredients for 1 minute on speed 1, then stop;
6. Add wet ingredients and mix for 5 minutes on speed 1, then stop;
7. Using a flat spatula, scrape the sides and bottom of the bowl;
8. Remove the bowl guard. Mix for 2 minutes on speed 2, then stop;
9. Repeat steps 7-8 until homogenous mixture is achieved.

It was found practical to limit the number of repetitions to no more than three times to avoid excess stiffening of the mixture.

Using silicone molds, the sample mixture formulations were molded into pucks having a diameter of 4 inches and a thickness of 0.8 inches. After curing, the volumetric shrinkage and surface cracks of the pucks were measured and recorded. Next, the burn-through rate of each puck was determined. An oxy-acetylene torch was used, providing a flame in excess of 6,000° F. as evidenced by the melting of a tungsten indicator strip on one of the pucks. The melting point of tungsten is 6,150° F.

During the burn-through rate test, the oxygen regulator was set to 20 psi and the acetylene regulator was set to 5 psi. The torch tip was a Victor model 5-1-101. The torch tip was placed so that the apex of the inner cone touched the surface of the sample, thus positioning the torch tip approximately one inch from the surface of the sample. The oxygen cutting lever was fully depressed, which produced an oxidizing flame until burn-through was achieved. Burn-through was detected visually or by thermocouples positioned in the substrate supporting the puck.

Of the experiments conducted, 26 mixtures were found to have characteristics for a practical thermal protective material. Mixture formulations 1-8, described in Tables 2A and 2B, were explored to determine how the adhesive constituent affects workability of the mixture in its pliant state. A workability test was used to determine how flowable or stiff the mixture was. If the material could be formed into a ball or flat plate with a gloved hand then it was determined to be workable. The samples were allowed to dry for two weeks at 50% relative humidity and 73° F. before testing; however, it is believed that less time could be used successfully in other testing.

TABLE 2A
Constituents

| | | Weight Percent | | |
|---|---|---|---|---|
| | Polysaccharide to Sodium | | Sodium | |
| Mix | Bicarbonate Ratio | Polysaccharide | Bicarbonate | Adhesive |
| 1 | 80:20 | 47 | 12 | 41 |
| 2 | 70:30 | 41 | 18 | 42 |
| 3 | 60:40 | 37 | 24 | 39 |
| 4 | 50:50 | 31 | 31 | 38 |
| 5 | 40:60 | 26 | 39 | 35 |
| 6 | 30:70 | 21 | 49 | 30 |
| 7 | 20:80 | 14 | 57 | 28 |
| 8 | 10:90 | 7 | 66 | 26 |

TABLE 2B
Test Results

| | Polysaccharide to | | | | Burn- |
|---|---|---|---|---|---|
| | Sodium | | | Shrinkage | through |
| | Bicarbonate | Cracking | Workability | (% | Rate |
| Mix | Ratio | (inches) | Test | volume) | (s/in) |
| 1 | 80:20 | 0 | Passed | 6.7 | 54 |
| 2 | 70:30 | 0.03 | Passed | 7.1 | 57 |
| 3 | 60:40 | 0.08 | Passed | 5.2 | 71 |
| 4 | 50:50 | 0 | Passed | 4.3 | 61 |
| 5 | 40:60 | 0 | Passed | 4.0 | 73 |
| 6 | 30:70 | 0 | Passed | 3.6 | 84 |
| 7 | 20:80 | 0 | Passed | 1.9 | 89 |
| 8 | 10:90 | 0 | Passed | 2.2 | 93 |

Mixture formulations 9-16, described in Tables 3A and 3B, were explored to determine how a constant adhesive constituent affects the characteristics of the thermal protective material when cured (dry). The samples were allowed to dry for two weeks before testing.

TABLE 3A
Constituents

| | Polysaccharide to | Weight Percent | | |
|---|---|---|---|---|
| | Sodium Bicarbonate | | Sodium | |
| Mix | Ratio | Polysaccharide | Bicarbonate | Adhesive |
| 9 | 80:20 | 46 | 12 | 42 |
| 10 | 70:30 | 41 | 17 | 42 |
| 11 | 60:40 | 35 | 23 | 42 |
| 12 | 50:50 | 29 | 29 | 42 |
| 13 | 40:60 | 23 | 35 | 42 |
| 14 | 30:70 | 17 | 41 | 42 |
| 15 | 20:80 | 12 | 46 | 42 |
| 16 | 10:90 | 6 | 52 | 42 |

TABLE 3B
Test Results

| | Polysaccharide to | | | | Burn- |
|---|---|---|---|---|---|
| | Sodium | | | Shrinkage | through |
| | Bicarbonate | Cracking | Workability | (% | Rate |
| Mix | Ratio | (inches) | Test | volume) | (s/in) |
| 9 | 80:20 | 0.08 | Passed | 6.3 | 43 |
| 10 | 70:30 | 0.07 | Passed | 6.6 | 40 |
| 11 | 60:40 | 0.05 | No Pass | 5.2 | 40 |
| 12 | 50:50 | 0.02 | No Pass | 4.3 | 37 |
| 13 | 40:60 | 0.01 | No Pass | 4.1 | 45 |
| 14 | 30:70 | 0 | No Pass | 2.0 | 55 |
| 15 | 20:80 | 0 | No Pass | 2.4 | 59 |
| 16 | 10:90 | 0 | No Pass | 1.9 | 76 |

Mixture formulations 17-23, described in Tables 4A and 4B, were explored to determine the effect of sodium borate on curing time. The samples were allowed to dry for one weeks before testing, achieving an optimum level of dryness a week sooner than mixtures 1-16. The ratio of polysaccharide to sodium bicarbonate was held constant at 80:20 for formulations 17-23. The sodium borate was added as a 5% aqueous solution.

TABLE 4A
Constituents
Polysaccharide to Sodium Bicarbonate
Ratio Approximately Constant 80:20

| | Weight Percent | | | | |
|---|---|---|---|---|---|
| | | | | | 5% |
| | | | | | Sodium |
| | | Sodium | | | Borate |
| Mix | Polysaccharide | Bicarbonate | Adhesive | Water | Solution |
| 17 | 44 | 11 | 34 | 11 | 0.4 |
| 18 | 42 | 11 | 32 | 14 | 0.7 |
| 19 | 43 | 11 | 33 | 14 | 0.1 |
| 20 | 40 | 10 | 30 | 20 | 0.13 |
| 21 | 37 | 9 | 29 | 25 | 0.12 |
| 22 | 44 | 11 | 34 | 11 | 0.15 |
| 23 | 46 | 11 | 35 | 8 | 0.15 |

TABLE 4B
Test Results
Polysaccharide to Sodium Bicarbonate
Ratio Approximately Constant 80:20

| | | | | Burn- |
|---|---|---|---|---|
| | | Shrinkage | Mass Lost | through |
| Mix | Cracking | (%) | (%) | Rate (s/in) |
| 17 | None | 0 | 1 | 50 |
| 18 | None | 1.25 | 10 | 63 |
| 19 | None | 6.8 | 36 | 45 |
| 20 | None | 2.5 | 39 | 45 |
| 21 | None | 4.5 | 41 | 53 |
| 22 | None | 7.3 | 31 | 56 |
| 23 | None | 7.0 | 27 | 56 |

Mixture formulations 24-26, described in Tables 5A and 5B, were explored to determine which polysaccharide to sodium bicarbonate ratio to produce the best burn-through rate and still have other useful properties when sodium borate constituent is held constant. The samples were allowed to dry for eight days before testing. A 5% sodium borate solution was used. The sodium borate solution was prepared by heating 100 g of water (tap water in these examples) in a beaker to a temperature below the boiling point of water, in this example, about 150° F. (65° C.), then adding 5 g of sodium tetraborate pentahydrate and stirring until the sodium tetraborate pentahydrate dissolved. The beaker was then allowed to cool to room temp. It is advantageous if the solution is prepared the same day as it will be used, because the sodium tetraborate pentahydrate may precipitate out over time.

Tables 5A and 5B respectively display the constituents and test results for formulations 24-26. Mixture 27 tested at a burn-through rate of 90 seconds per inch.

TABLE 5A
Constituents

| | | Weight Percent | | | | |
|---|---|---|---|---|---|---|
| | Polysaccharide | | | | | 5% |
| | to Sodium | | | | | Sodium |
| | Bicarbonate | | Sodium | | | Borate |
| Mix | Ratio | Polysaccharide | Bicarbonate | Adhesive | Water | Solution |
| 24 | 80:20 | 44 | 11 | 39 | 5.2 | 0.21 |
| 25 | 40:60 | 24 | 37 | 33 | 5.4 | 0.22 |
| 26 | 10:90 | 80 | 62 | 24 | 6.5 | 0.26 |

TABLE 5B
Test Results

| | Polysaccharide to | | | | Burn- |
|---|---|---|---|---|---|
| | Sodium | | | Shrinkage | through |
| | Bicarbonate | | Workability | (% | Rate |
| Mix | Ratio | Cracking | Test | Volume) | (s/in) |
| 24 | 80:20 | 0 | Pass | No data | No data |
| 25 | 40:60 | 0 | Pass | 1.8 | 90 |
| 26 | 10:90 | 0 | Pass | 1.8 | 80 |

It was found that the addition of sodium borate has the potential to decrease curing time, increase burn through time, and reduce the thickness of the final product. It is believed that sodium borate cross links with the polyvinyl acetate augmenting the adhesive component (glue). The cross linking is believed to make the final material denser and stronger as well as reduce the curing time. Water was used to dissolve the sodium borate and to also act like a dispersant.

For formulations comprising a polysaccharide, sodium bicarbonate and an adhesive, testing was conducted wherein the polysaccharide comprises from 7 weight percent to 93 weight percent, wherein the sodium bicarbonate comprises from 9 weight percent to 66 weight percent, and wherein the adhesive comprises from 26 weight percent to 42 weight percent. For formulations additionally comprising water and sodium borate, testing was conducted for the range, wherein the water comprises from 5 weight percent to 25 weight percent and wherein the sodium borate comprises from 0.1 weight percent to 0.7 weight percent of a 5 percent solution of sodium borate.

The tests were conducted by varying the polysaccharide to sodium bicarbonate ratio in increments of ten. For example, going from 90 parts polysaccharide: 10 parts sodium bicarbonate to 80 parts polysaccharide: 20 parts sodium bicarbonate. Varying these ratios resulted in the overall 7-93 percent weight and 9-66 percent weight ranges, respectively.

The adhesive content varied according to workability. Acceptable workability was determined from a mechanical test which required that the mixture be rollable into a ball without being tacky to the touch, thereafter hold its shape, and then be pressed into a disk without cracking. As the baking soda content is increased, the amount of adhesive needed for workability is decreased. Changing the polysaccharide to sodium bicarbonate ratio affects the amount of glue required to hold form, which resulted in the 26-42 percent weight range.

Water content and 5% aqueous sodium borate solution were varied to determine the optimal concentrations, which resulted in the 5-25 percent weight and the 0.12-0.7 percent weight, respectively. Optimal formulations were determined by mixtures that satisfied the workability test, displayed acceptable shrinkage and curing (drying) times, as well as practical burn through rates.

Formulations within the claimed ranges are expected to provide effective thermal protection, commensurate with the test results for the specific formulations described herein, which are derived from representative samples of thermal protective material falling within the scope of the claimed invention.

It is expected that example thermal protective material formulations according to the invention will provide protection for structural members as well as surfaces and thereby avoid the deleterious effects when such elements are subjected to high temperatures, for example, in excess of 6,000° F.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

1.-42. (canceled)

43. A method of preparing a thermal protective material using a formulation, the formulation comprising:
a polysaccharide;
sodium bicarbonate;
an adhesive; and
sodium borate,
said method comprising:
mixing said polysaccharide and said sodium bicarbonate;
during said mixing, adding said adhesive and said sodium borate to said polysaccharide and said sodium bicarbonate thereby forming a mixture.

44. The method according to claim 43, said method further comprising during said mixing adding.

45. The method according to claim 43, said method further comprising halting said mixing and allowing said mixture to cure.

46. (canceled)

47. The method according to claim 43, further comprising applying said mixture to a substrate and then allowing said mixture to cure.

48. (canceled)

49. (canceled)

50. (canceled)

51. The method according to claim 43, further comprising applying said mixture to a substrate after allowing said mixture to cure.

52.-66. (canceled)

67. The method according to claim 43, further comprising halting said mixing and shaping said mixture into a geometric form, wherein said geometric form is a coating, a layer, a plate, a block, or combinations thereof.

68. The method according to claim 67, further comprising allowing said mixture to cure after shaping said mixture.

69. The method according to claim 67, further comprising applying said mixture to a substrate after shaping said mixture.

70. The method according to claim 68, further comprising applying said mixture to a substrate after allowing said mixture to cure.

71. The method according to claim 44, wherein said polysaccharide comprises 43.9 weight percent, said sodium bicarbonate comprises 10.9 weight percent, said adhesive comprises 33.6 weight percent, said water comprises 10.9 weight percent and said sodium borate comprises 0.4 weight percent of a 5 percent solution of sodium tetraborate pentahydrate.

72. The method according to claim 44, wherein said polysaccharide comprises 42.3 weight percent, said sodium bicarbonate comprises 10.6 weight percent, said adhesive comprises 32.4 weight percent, said water comprises 14.1 weight percent and said sodium borate comprises 0.7 weight percent of a 5 percent solution of sodium tetraborate pentahydrate.

73. The method according to claim 44, wherein said polysaccharide comprises 42.5 weight percent, said sodium bicarbonate comprises 10.6 weight percent, said adhesive comprises 32.6 weight percent, said water comprises 14.2 weight percent and said sodium borate comprises 0.1 weight percent of a 5 percent solution of sodium tetraborate pentahydrate.

74. The method according to claim 44, wherein said polysaccharide comprises 39.7 weight percent, said sodium bicarbonate comprises 9.9 weight percent, said adhesive comprises 30.4 weight percent, said water comprises 19.8 weight percent and said sodium borate comprises 0.13 weight percent of a 5 percent solution of sodium tetraborate pentahydrate.

75. The method according to claim 44, wherein said polysaccharide comprises 37.2 weight percent, said sodium bicarbonate comprises 9.3 weight percent, said adhesive comprises 28.5 weight percent, said water comprises 24.8 weight percent and said sodium borate comprises 0.12 weight percent of a 5 percent solution of sodium tetraborate pentahydrate.

76. The method according to claim 44, wherein said polysaccharide comprises 44.0 weight percent, said sodium bicarbonate comprises 11.0 weight percent, said adhesive comprises 33.7 weight percent, said water comprises 11.0 weight percent and said sodium borate comprises 0.15 weight percent of a 5 percent solution of sodium tetraborate pentahydrate.

77. The method according to claim 44, wherein said polysaccharide comprises 45.7 weight percent, said sodium bicarbonate comprises 11.4 weight percent, said adhesive comprises 35.1 weight percent, said water comprises 7.6 weight percent and said sodium borate comprises 0.15 weight percent of a 5 percent solution of sodium tetraborate pentahydrate.

78. The method according to claim 44, wherein said polysaccharide comprises 44.2 weight percent, said sodium bicarbonate comprises 11.0 weight percent, said adhesive comprises 39.4 weight percent, said water comprises 5.2 weight percent and said sodium borate comprises 0.21 weight percent of a 5 percent solution of sodium tetraborate pentahydrate.

79. The method according to claim 44, wherein said polysaccharide comprises 24.4 weight percent, said sodium bicarbonate comprises 36.6 weight percent, said adhesive comprises 33.4 weight percent, said water comprises 5.4 weight percent and said sodium borate comprises 0.22 weight percent of a 5 percent solution of sodium tetraborate pentahydrate.

80. The method according to claim 44, wherein said polysaccharide comprises 6.9 weight percent, said sodium bicarbonate comprises 62.4 weight percent, said adhesive comprises 23.9 weight percent, said water comprises 6.5 weight percent and said sodium borate comprises 0.26 weight percent of a 5 percent solution of sodium tetraborate pentahydrate.

81. The method according to claim 43, wherein said sodium borate comprises from 0.1 weight percent to 0.7 weight percent of a 5 percent solution of sodium borate.
